(19) United States
(12) Patent Application Publication
(10) Pub. No.: US 2025/0113154 A1
(43) Pub. Date: Apr. 3, 2025

(54) Spatial Audio Conversation Channel

(71) Applicant: Apple Inc., Cupertino, CA (US)

(72) Inventors: Christopher T. Eubank, Santa Barbara, CA (US); Ronald J. Guglielmone, JR., Redwood City, CA (US); Michael C. Friedman, Nederland, CO (US); Robert D. Silfvast, Belmont, CA (US)

(21) Appl. No.: 18/777,436

(22) Filed: Jul. 18, 2024

Related U.S. Application Data
(60) Provisional application No. 63/586,288, filed on Sep. 28, 2023.

(51) Int. Cl. H04S 7/00

(52) U.S. Cl. CPC H04S 7/302

(57) ABSTRACT

An opt-in indication is received that a wearer of a headworn device joins a conversation channel having a first target audio signal that contains an isolated voice of a first talker. In response, the first target audio signal is spatially rendered into a left speaker driver signal and a right speaker driver signal that are to drive a left speaker and a right speaker, respectively, of a first audio system. Other aspects are also described and claimed.

This patent application claims the benefit of the earlier filing date of U.S. provisional patent application No. 63/586,288 filed 28 Sep. 2023.

### FIELD

An aspect of the disclosure here relates to digital audio signal processing techniques that enable a more pleasant listening experience for a wearer of a headset to hear another talker, during a conversation in a noisy ambient environment. Other aspects are also described and claimed.

### BACKGROUND

Having a conversation with someone who is nearby in a noisy environment, such as in a restaurant, bar, airplane, or a bus, takes effort as it is difficult to hear and understand the other person. A solution that may reduce this effort is to wear headphones that passively isolate the wearer from the noisy environment while actively reproducing the other person's voice through the headphone's speakers in a so-called transparency function. Such selective reproduction of the sounds in the ambient environment may be achieved by applying beamforming signal processing to the output of a microphone array in the headphones, which focuses sound pickup in the forward direction where the other talker is assumed to be (and at the same time de-emphasizes or suppresses the pickup of sounds from other directions.) The resulting beamformed audio signal then drives the headphone speaker to complete the transparency function.

### SUMMARY

It would be desirable to enable a wearer of headphones that have a transparency function to converse even more effortlessly in daily life, when having a conversation with one or more other talkers in a noisy, acoustic ambient environment. Various aspects of a more immersive transparency function having a spatialized audio conversation channel are described.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have particular advantages not specifically recited in the above summary.

### BRIEF DESCRIPTION OF THE DRAWINGS

Several aspects of the disclosure here are illustrated by way of example and not by way of limitation in the figures of the accompanying drawings. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is a diagram of a first audio system, in which various aspects of the disclosure here can be implemented.

FIG. 2 is a diagram of the case where there is also a second audio system being used by the Other Talker.

FIG. 3 is a flow diagram used to illustrate various versions of a method for spatial audio rendering of a conversation channel.

### DETAILED DESCRIPTION

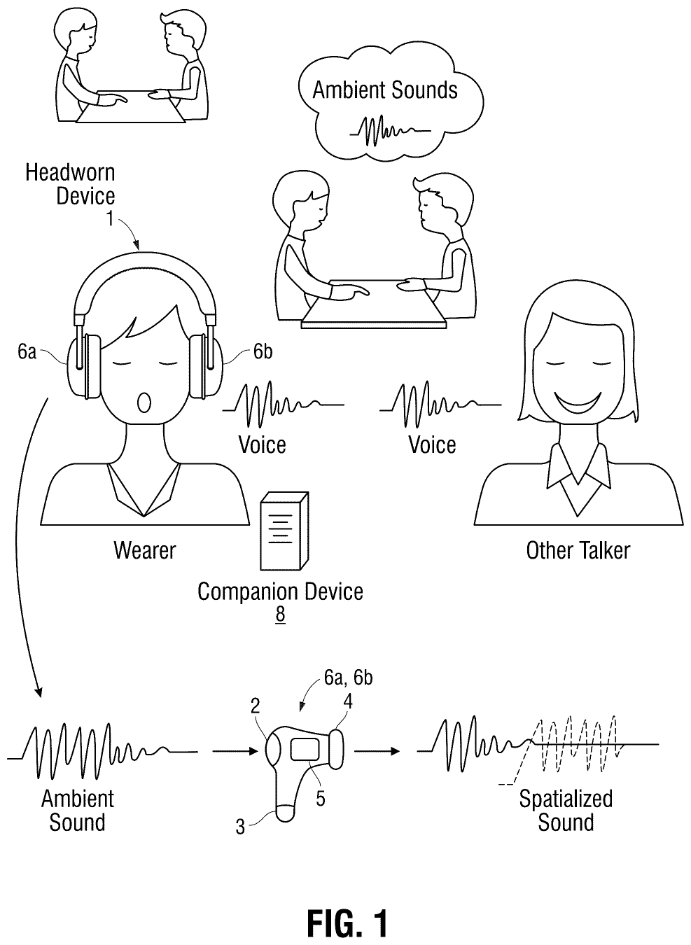

FIG. 1 is a block diagram of elements of an audio system in which the aspects of the disclosure here may be implemented. The system has a digital processor 5 that is configured or programmed for example in accordance with instructions stored in a non-transitory machine-readable medium (not shown), e.g., solid state memory, to perform the operations described below, for reducing listening effort by a Wearer in a noisy ambient environment. The ambient environment depicted in the example of FIG. 1 has a first talker (labeled as “Other Talker”) in a real environment of the Wearer, for example within the same room or vehicle cabin as the Wearer. The ambient environment is noisy in that there are distractions that would be heard by the Wearer, such as other conversations (two are shown as an example), and other distracting sources such as music.

In the example shown, the processor 5 is integrated in the housing of a headworn device 1 that is worn by a Wearer (e.g., a person or user.) The headworn device 1 in this case is a headset having a left headphone 6b and a right headphone 6a worn at the left and right ears, respectively. As shown, the headphones 6a, 6b are of the over-the-ear type and are fixed to each other by a bridge section over the wearer's head. Each headphone 6a, 6b has at least one speaker 4 that is positioned at the ear, several microphones including one or more external microphones (e.g., a reference microphone 2 configured for direct pick up of ambient environment sounds and a voice microphone 3 that is positioned closer to the wearer's mouth), and one or more internal microphones (not shown) that are configured for direct pick up of sound at the entrance of or within an ear canal. The audio system thus has a left instance of the speaker 4 (a left speaker) and a right instance of the speaker 4 (a right speaker), which are to spatially reproduce the sound of a target audio signal as described in more detail below. There may be additional sensors in the headworn device 1 whose outputs may be used in some aspects described below, to spatially render the target audio signal, e.g., an accelerometer (e.g., for bone conduction pickup of the wearer's voice), and a gyroscope (e.g., as part of an inertial measurement unit, for use as part of an inertial head tracking subsystem.) Also, while not shown, in another instance of the first audio system, its external microphone may be in a companion device 8 to the headworn device 1, such as a smartwatch worn by the Wearer or a smartphone belonging to the Wearer.

Another form of the headworn device 1 (that is not shown) is an augmented reality, AR, headset, whose form factor may be goggles, eyeglasses or a helmet. The Other Talker could be visible to the Wearer via a display panel of the AR headset (e.g., passthrough AR glasses, or as captured in a camera image produced by an outward and front-facing camera of the AR headset and displayed by the display panel), for example together with the rest of the real environment. In one instance, the AR headset has no headphones, and the spatial reproduction of the target audio signal is through the left instance and right instance of the speaker 4 which are extra-aural speakers in a housing of the AR headset, for example attached to the stems of a pair of passthrough AR eyeglasses or attached to a head strap against the left and right temples of the Wearer.

In one variation of the AR headset-based version of the audio system, the spatial reproduction of the target audio signal is through the right and left speakers that are integrated in the housings of the headphones 6a, 6b, respectively. The headphones 6a, 6b in that case may be physically separate from the AR headset, while the Wearer is wearing both. An example of one of the headphones 6a, 6b that is suitable for such use is an earbud (or in-ear headphone) which is shown at the bottom of FIG. 1. In this variation, the Wearer is wearing both the AR headset and the headphones 6a, 6b as part of the audio system, and the audio system is reproducing the sound of the target audio signal through the speakers in the headphones 6a, 6b. Some of the control and audio signal processing that leads to the target audio signal (as discussed below) may be performed by a processor in the AR headset, and some may even be performed by a processor in a companion device 8.

The operations of the audio system described below, which are part of a method for spatial audio rendering of a conversation channel, can be performed in several ways. In one instance, they are performed entirely by a single microprocessor which may be within the housing of the headworn device 1 (e.g., the AR headset, or in a combination of the AR headset and a separate pair of headphones 6a, 6b); in other instances, they may be performed in a distributed fashion, where some of the operations are performed by a microprocessor in the headworn device 1, while others are being performed by a microprocessor in the companion device 8. The companion device 8 may be for instance a smartphone that belongs to the wearer, and that transmits a result of the spatial audio rendering, e.g., the left and right speaker driver signals, to the headworn device 1 where they are converted into sound at the ears of the wearer. Note here that the operations described below that are said to be performed by “a processor” or “the processor” may be distributed across multiple microprocessors, e.g., some are performed by a microprocessor that is in the companion device 8, while some others are performed by a microprocessor that is in the head-worn device 1, and still others could be performed by for example a server that the companion device 8 or the headworn device 1 reaches via the Internet.

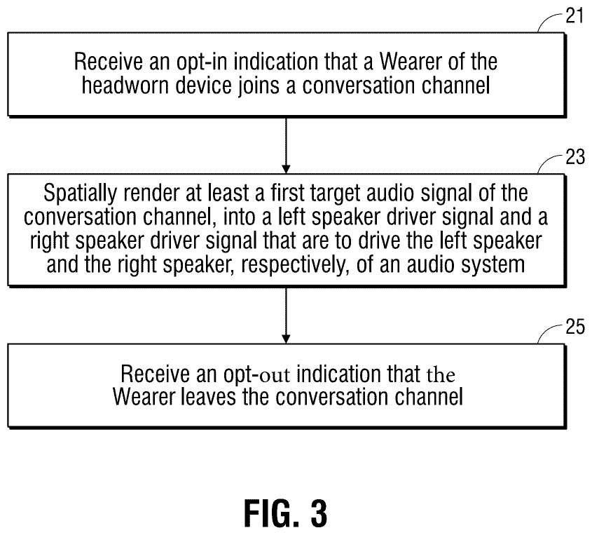

Referring now to FIG. 3, this is a flow diagram that is used to illustrate various versions of, and particular aspects of, the spatial audio rendering method here. The method may begin with operation 21 in which the processor receives an opt-in indication that a wearer of the headworn device 1 joins a conversation channel. The conversation channel may be a data structure that includes one or more target audio signals, in digital form or as separate bitstreams, including a first target audio signal that contains an isolated voice of a first talker. In the example of FIG. 1, that would be the voice of the Other Talker. In addition, the conversation channel contains metadata for each target audio signal including a direction of the Other Talker (e.g., relative to a front-directed central axis of the headworn device 1.)

The opt-in indication may be a selection made by the Wearer, e.g., through virtual assistant software executing in the headworn device 1 or in the companion device 8 that prompts the Wearer. The actual command from the Wearer may be received by the virtual assistant software as a touch (operating through a touchscreen of the companion device 8) or as speech (through a microphone of the headworn device 1.)

In one aspect, the first target audio signal is produced by the first audio system processing an output of a microphone array in the first audio system. The first audio system encompasses an instance of the headworn device 1 that is worn by the Wearer, and optionally the Wearer's companion device 8. The first target audio signal may be a mono audio signal such as the voice of the Other Talker, with metadata that indicates for example at least an azimuth direction toward a sound source that is expected to be the Other Talker. The processing of the microphone array output to isolate the voice of the Other Talker may also be informed by output from other sensors in the headworn device 1. For example, consider the case where the headworn device 1 has a front-facing or outward facing camera subsystem (in contrast to an inward facing camera subsystem, such as part of an eye tracking subsystem, which is aimed at the eyes of the Wearer.) The images captured by the outward facing camera subsystem could be processed to detect the point in time when another talker (and in particular the Other Talker) is facing the Wearer, and also an azimuthal direction of arrival for the voice of the Other Talker. Such information means that at the present time, the front axis of the microphone array is in the direction of arrival of the voice of the Other Talker. This information may also serve as an automatic opt-in indication that the Wearer should join the conversation channel, or it may signal the virtual assistant to prompt the Wearer. The information may also be used to isolate the voice of the Other Talker, by for example pickup beamforming the output of the microphone array to produce a narrow pick up beam centered at the center axis, or by informing a voice separation machine learning model of the expected direction of arrival.

In one instance, the processing of the output of the microphone array (to produce the first target signal) is as follows. The processor performs a direction detection algorithm that outputs azimuth and optionally also elevation, as a target direction of a voice source relative to the Wearer's head (on which the headworn device 1 is worn.) The target direction is then provided to a voice isolation algorithm that processes the output of the microphone array to produce the first target audio signal. The voice isolation algorithm may include, for example, a sound pickup beamforming algorithm that suppresses sound coming from directions other than the target direction. A machine learning model could also be part of the voice separation algorithm. When the spatial audio rendering uses this target direction to render the first target audio signal, the Wearer will perceive the isolated voice as coming from the target direction which is expected to be the direction of the Other Talker. Note that in some instances, the Other Talker is behind the Wearer, and in that case the Wearer should perceive the isolated voice as coming from behind them.

As an alternative, the first target audio signal (derived from a microphone array in a headworn device) may be in Ambisonics format, accompanied with its metadata that indicates at least an azimuth direction toward a sound source in the sound scene that is expected to be the Other Talker.

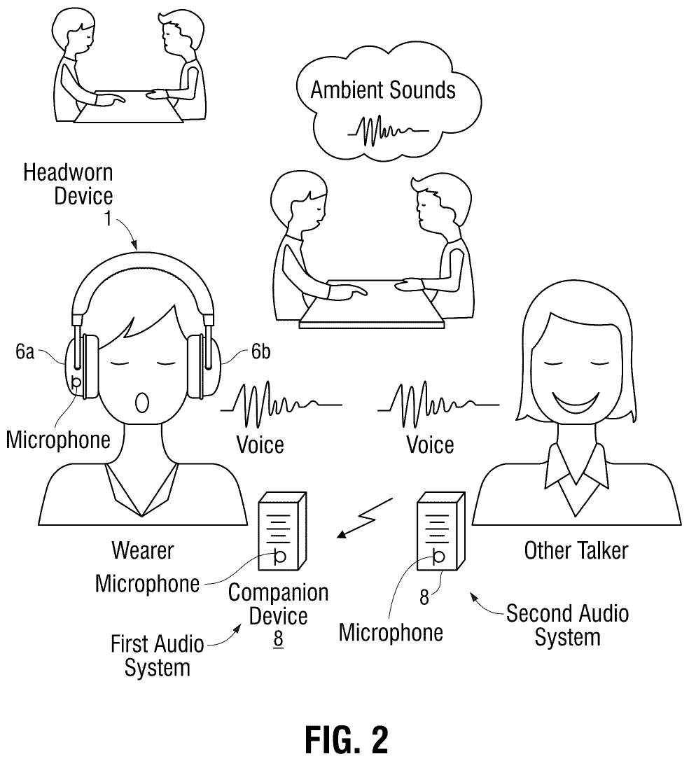

In another aspect, referring now to FIG. 2, the first target audio signal is produced by a second audio system that is digitally processing an output of one or more microphones in the second audio system, and transmitting the resulting bitstream in real time, over-the-air (e.g., via radio frequency waves symbolized by the lightning bolt symbol) to be received by the first audio system. The second audio system may encompass another instance of the headworn device 1, that is being worn by the Other Talker and optionally another instance of the companion device 8 which belongs to the Other Talker. Alternatively, the second audio system may not have any headworn device 1; for example, the second audio system may be simply another instance of the companion device 8 by itself, such as a smartwatch or a smartphone of the Other Talker whose microphone is picking up the voice of the Other Talker nearby. The processing by the second audio system that produces the first target audio signal may be described as an “own voice” process that isolates the voice of the Other Talker from other sounds in the ambient environment (such as conversations of others nearby as illustrated.) The own voice process could for example include output from bone conduction pick up in the second audio system (if such a sensor is available for example in an instance of the headworn device 1 that is worn by the Other Talker.)

In response to receiving the opt-in indication, spatial audio rendering of the first target audio signal is then performed (operation 23) into a left speaker driver signal and a right speaker driver signal that are to drive the left speaker and the right speaker, respectively, of the first audio system. In one instance, these left and right speaker driver signals are binaural signals (produced by a binaural rendering algorithm) which includes the effect of a head related transfer function, HRTF, filter selected for the Wearer.

The processor may then receive an opt-out indication that the Wearer leaves the conversation channel (operation 25.) In response, the processor may cease rendering the first target audio signal in the first audio system, such that, for example, the Wearer will no longer hear the isolated voice of the Other Talker being reproduced through the left and right speaker drivers of the first audio system.

In the case where, in the first audio system, the headworn device 1 is an AR headset and the first talker (Other Talker) is in a real environment of the wearer and may be visible through a display panel of the AR headset or not (if the Other Talker is behind the Wearer), the following features may be added to the first audio system to provide a spatial, or more immersive, conversation experience via the transparency function of the first audio system.

In one feature, the processor determines whether the head of the Wearer is in the direction of a voice source that is in the ambient environment (also referred to as a target direction.) This may be based on the processor i) detecting gaze of the Wearer using an inward-facing camera of the AR headset, ii) processing images from a front-facing or outward facing camera of the AR headset to detect the face of the Other Talker, or both i) and ii), in addition to optionally using other inputs such as acoustical-based processing of the microphone array. In response to determining that the Wearer head direction is in the target direction, the processor may generate the opt-indication and in response to that the virtual assistant may prompt the Wearer for their decision on whether to join a conversation channel. In one instance of this feature, after generating the opt-in indication, the processor in real time tracks the target direction of the voice source (which may change) using only acoustical-based processing of the output of the microphone array, to inform the subsequent spatial audio rendering (operation 23.) For example, an acoustical direction of arrival continuous tracking algorithm is performed, not gaze processing or outward facing camera processing, which advantageously reduces power consumption by the headworn device 1 or by the companion device 8. Here, the processor is also tracking the Wearer's head direction in real time, and so both the tracked direction of the Wearer's head and the tracked direction of arrival are provided to spatially render the conversation channel.

The processor recognizes and tracks the face of the Other Talker, in images that are being captured in real time by the outward facing camera subsystem of the AR headset. The spatial audio rendering (operation 23 in FIG. 3) now includes rendering, using a first spatial audio filter, the first target audio signal as a point source that is positioned on the tracked face of the Other Talker. In other words, the virtual location of the point source for the purpose of spatially rendering the first target audio signal corresponds to, or is, the location of the tracked face of the Other Talker. The spatial audio filter is then configured or updated in real time, while rendering the first target audio signal, based on not just the position of the tracked face of the Other Talker but also according to a determined, changing position of the Wearer. In one instance, the processor is continuously determining in real time the changing position of the Wearer by processing an output of one or more sensors in the first audio system using a visual odometry technique or a visual simultaneous localization and mapping technique or using an ultra-wideband time of flight localization technique to sense a position of the Other Talker. As a result, the transparency function in the first audio system provides the Wearer a more immersive conversation experience even when the Wearer starts to move around.

Although FIG. 1 shows a single Other Talker (or a first talker whose isolated voice is in the conversation channel), the conversation channel may be configured to also include a second target audio signal that contains the isolated voice of a second Other Talker (not shown.) The second Other Talker (or a second talker) is also in the real environment of the Wearer and would be visible via the display panel of the Wearer's AR headset. As with the first target audio signal described above, the second target audio signal may be produced in one of two ways: it may be produced by a third audio system processing an output of one or more microphones in a third audio system (e.g., an instance of the headworn device 1 being worn by the second talker, together with a companion device such as a smartphone that belongs to the second talker, or just the companion device as a smartphone for example—see FIG. 2—and then received by the first audio system over-the-air from the third audio system; or, it may be produced by the first audio system processing an output of the microphone array in the first audio system to isolate the voice of the second talker from other sounds in the ambient environment of the first audio system.

In both of the above scenarios, in response to receiving the opt-in indication, the processor may begin tracking the face of the Other Talker, in the images that are being captured in real time by the outward facing camera subsystem of the AR headset. Also, the second target audio signal is rendered using a second spatial audio filter, as a point source that is positioned on the tracked face of the second talker (that is visible via the display panel of the AR headset.) Moreover, the second spatial audio filter is configured or updated in real time (while spatially rendering the second target audio signal) according to the changing position of the wearer. In this manner, the Wearer continues to enjoy the conversation channel in an immersive manner, when there are two Other Talkers in it.

In one aspect, the second audio system and the third audio system each sends metadata along with their respective second and third target audio signals, which includes a dynamic range of or an average speech level of the voice of the first and second Other Talkers, respectively. This information may be used by the processor in the first audio system, to, for example, adjust a playback level of each of the first target audio signal and the second target audio signal. For instance, if the first talker has a much louder voice than the second talker, then the processor in operation 23 uses the metadata during rendering to bring two voice levels closer to each other which avoids drowning out the softer voice of the second talker.

In another aspect related to controlling the playback level of the voice of the Other Talker, consider the case where the Wearer is wearing the AR headset. The processor in that case may be configured to detect when the Wearer is gazing at a face of the first talker via the display panel of the AR headset (using the output of the eye tracking subsystem and by tracking the location of the face of the first talker in the images from the outward facing camera subsystem.) In response, the processor enables the Wearer to manually adjust a playback level of the first target audio signal (but it does not automatically change the playback level.) The playback level is then adjusted by the processor, according to the setting of either a virtual variable level control element that is being presented on the display panel of the AR headset, or a physical variable level control element in the first audio system (e.g., a volume control button in the companion device or in the AR headset.) Once the Wearer has stopped gazing at the face of the first talker, the processor removes the manual playback level adjustment feature, and the playback level previously set by the Wearer remains in place (for the first target audio signal.)

Another aspect related to controlling the playback level of the voice of the Other Talker, in the case where the Wearer is wearing the AR headset, is a manual override feature. Here, a default mode of operation may be that when the processor detects the Wearer is gazing at the face of the first talker (via the display panel of the AR headset), it first responds by making an automatic change (without using any explicit input from the Wearer) to raise or lower the playback volume of the first target audio signal. The processor then enables the Wearer to manually override the automatic change, via the virtual control element shown on the display panel or via a physical control element in the first audio system. In other words, after the initial automatic change to the playback level, the processor responds to the Wearer's request to raise or lower the playback level (that it detects via either the virtual control element or the physical control element.)

And in still another aspect related to controlling the playback level of the voice of the Other Talker, the processor makes an automatic change to (or adjusts) the playback volume of the first target audio signal using a direct sound path parameter that describes the direct sound path from the first talker to the AR headset. The direct sound path parameter may be determined by the processor, for example computing (estimating) the distance from the first talker to the AR headset (e.g., using the images produced by the outward facing camera subsystem.)

It is well understood that the use of personally identifiable information should follow privacy policies and practices that are recognized as meeting or exceeding industry or governmental requirements for maintaining the privacy of users. In particular, personally identifiable information or data should be managed and handled so as to minimize risks of unintentional or unauthorized access or use, and the nature of authorized use should be clearly indicated to users.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

While certain aspects have been described and shown in the accompanying drawings, it is to be understood that such are merely illustrative of and not restrictive on the broad invention, and that the invention is not limited to the specific constructions and arrangements shown and described, since various other modifications may occur to those of ordinary skill in the art. For example, while FIG. 1 depicts the headworn device 1 having a headset having headphones 6a, 6b attached thereto, it is possible as was described above for the headworn device 1 to alternatively be an AR headset with attached extra-aural speakers. The description is thus to be regarded as illustrative instead of limiting.

What is claimed is:

1. A method for spatial audio rendering of a conversation channel in a first audio system having a headworn device, the method comprising the following operations performed by a digital processor in the first audio system:
receiving an opt-in indication that a wearer of the headworn device join a conversation channel, wherein the conversation channel comprises a first target audio signal that contains an isolated voice of a first talker, the first target audio signal being
i) produced by processing an output of one or more microphones in a second audio system, and then received by the first audio system over-the-air from the second audio system, or
ii) produced by the first audio system processing an output of a microphone array in the first audio system; and
in response to receiving the opt-in indication, spatial audio rendering the first target audio signal into a left speaker driver signal and a right speaker driver signal that are to drive a left speaker and a right speaker, respectively, of the first audio system.

2. The method of claim 1 wherein the headworn device is an augmented reality headset or an AR headset, and the first talker is in a real environment of the wearer.

3. The method of claim 2 wherein the left speaker and the right speaker are extra-aural speakers in a housing of the AR headset.

4. The method of claim 2 wherein the first audio system further comprises, in addition to the AR headset, a left headphone housing and right headphone housing in which the left speaker and the right speaker, respectively, are integrated.

5. The method of claim 2 further comprising:
detecting that the wearer is gazing at a face of the first talker, and in response enable the wearer to manually adjust a playback level of the first target audio signal via a virtual variable level control element shown on a display panel or via a physical variable level control element in the first audio system.

6. The method of claim 2 further comprising:
detecting that the wearer is gazing at a face of the first talker and in response making an automatic change, without input from the wearer, to raise or lower a playback volume of the first target audio signal; and
enabling the wearer to manually override the automatic change via a virtual control element shown on a display panel or via a physical control element in the first audio system.

7. The method of claim 2 further comprising:
determining a direct sound path parameter from the first talker to the AR headset; and
using the direct sound path parameter to adjust a playback volume of the first target audio signal.

8. The method of claim 2 further comprising:
determining a changing position of the wearer of the AR headset by processing an output of one or more sensors in the first audio system using a visual odometry technique or a visual simultaneous localization and mapping technique,
and wherein the spatial audio rendering comprises
spatially rendering, using a first spatial audio filter, the first target audio signal as a point source that is positioned on a face of the first talker, the first spatial audio filter being configured, while spatially rendering the first target audio signal, according to the changing position of the wearer of the AR headset.

9. The method of claim 8 wherein the conversation channel further comprises a second target audio signal that contains isolated voice of a second talker, the second target audio signal
i) produced by processing an output of one or more microphones in a third audio system and then received by the first audio system over-the-air from the third audio system, or
ii) produced by the first audio system processing an output of the microphone array in the first audio system,
the method further comprising
in response to receiving the opt-in indication, spatial audio rendering the second target audio signal into the left speaker driver signal and the right speaker driver signal.

10. The method of claim 9 further comprising:
determining a changing position of the face of the first talker,
and wherein the spatial audio rendering comprises
configuring the first spatial audio filter according to the changing position of the face of the first talker.

11. The method of claim 10 wherein the first target audio signal is produced by one or more microphones in the second audio system and then received by the first audio system over-the-air, and the determining the changing position of the face of the first talker comprises:
using an ultra-wideband time of flight localization technique to sense a position of the first talker.

12. The method of claim 10 wherein the second talker is in a real environment of the wearer and is i) depicted in a camera image of the real environment that is being displayed by a display panel of an AR headset, or ii) visible by the wearer through the display panel of the AR headset, and the spatial audio rendering further comprises
spatially rendering, using a second spatial audio filter, the second target audio signal as another point source that is positioned on a face of the second talker, wherein the face of the second talker is displayed by or is visible through the display panel of the AR headset, the second spatial audio filter being configured, while spatially rendering the second target audio signal, according to the changing position of the wearer.

13. The method of claim 1 further comprising:
receiving metadata from the second audio system, wherein the metadata includes dynamic range of or an average speech level of voice of the first talker and using the metadata to adjust a playback level of first target audio signal.

14. The method of claim 1 wherein the first target audio signal is produced by processing the output of the microphone array in the first audio system, which processing comprises:
performing a direction detection that outputs azimuth and elevation, or a target direction, of a voice source, relative to a head of the wearer; and
providing the target direction to a voice isolation algorithm that processes the output of the microphone array to produce the first target audio signal,
and wherein the spatial audio rendering uses the target direction to render the first target audio signal so that the wearer perceives the isolated voice as coming from the target direction.

15. The method of claim 14 further comprising
determining whether a wearer head direction of the wearer of the headworn device is in the target direction, based on i) detecting gaze of the wearer using an inward-facing camera of an AR headset, ii) processing images from a front-facing camera of the AR headset, or both i) and ii); and
in response to determining that the wearer head direction is in the target direction, generating the opt-in indication.

16. The method of claim 15 further comprising:
after generating the opt-in indication, tracking the target direction of the voice source using only acoustical-based processing of the output of the microphone array, while tracking the wearer head direction, to inform the spatial audio rendering.

17. The method of claim 1 wherein the headworn device is a pair of headphones.

18. The method of claim 1 further comprising:
receiving an opt-out indication that the wearer of the headworn device leave the conversation channel; and
in response to the opt-out indication, cease rendering the first target audio signal in the first audio system.

19. An audio system comprising a processor and memory having stored therein instructions that program the processor to perform the following operations:
receiving an opt-in indication that a wearer of a headworn device in a first audio system join a conversation channel, wherein the conversation channel comprises a first target audio signal that contains an isolated voice of a first talker, the first target audio signal being
i) produced by processing an output of one or more microphones in a second audio system, and then received by the first audio system over-the-air from the second audio system, or
ii) produced by the first audio system processing an output of a microphone array in the first audio system; and
in response to receiving the opt-in indication, spatial audio rendering the first target audio signal into a left speaker driver signal and a right speaker driver signal that are to drive a left speaker and a right speaker, respectively, of the first audio system.

20. The audio system of claim 19 wherein the processor comprises a first microprocessor in an augmented reality headset or an AR headset.

21. The audio system of claim 20 wherein the processor comprises a second microprocessor in a companion device to the AR headset.

22. The audio system of claim 19 wherein the processor comprises a first microprocessor in a headphone.

23. The audio system of claim 22 wherein the processor comprises a second microprocessor in a companion device to the headphone.
